(19) United States
(12) Patent Application Publication
(10) Pub. No.: US 2022/0144393 A1
(43) Pub. Date: May 12, 2022

(54) AN APPARATUS AND METHOD OF MEASURING, MONITORING, RECORDING AND VERIFYING THE UP-TAKE AND DISCHARGE OF BALLAST WATER ON MARINE VESSELS TO ENSURE THAT THE BALLAST WATER TO BE DISCHARGED COMPLIES WITH THE BALLAST WATER DISCHARGE STANDARDS

(71) Applicant: Kok Loon NG, Singapore (SG)

(72) Inventor: Kok Loon NG, Singapore (SG)

(21) Appl. No.: 17/283,473

(22) PCT Filed: Oct. 7, 2019
(86) PCT No.: PCT/SG2019/050502

§ 371 Date: Apr. 7, 2021

(30) Foreign Application Priority Data
Oct. 7, 2018 (SG) 10201808840U

(51) Int. Cl. B63B 79/30; B63B 39/03; B63B 79/10

(52) U.S. Cl. CPC B63B 79/30; B63B 79/10; B63B 39/03

(57) ABSTRACT

An apparatus and method of measuring, monitoring, recording and verifying the uptake and discharge of ballast water on marine vessels to ensure that they comply with the ballast water discharge standards set by international bodies, the apparatus includes an arrangement of small sampling pipes, valves, sampling pump, flow meter, Ballast Water Monitor, Ballast Water Sensors Module and Controller. The method comprises measuring the concentration of the bacteria and pathogens in the sampled ballast water during ballasting and de-ballasting by the Ballast Water Monitor and compared against the regulatory standards and historical data of similar ship data and ballast water data. The method also identifies and isolates specific ballast water tank that holds non-compliant ballast water so that when compliant water is available, the non-complaint ballast water shall be flushed out from the identified specific ballast water tank with the compliant water. All information are saved in a secure, tamper-proof and encrypted format so that they are verifiable and traceable to ensure that no non-compliance ballast water has been discharged overboard at ports at all times.

### BACKGROUND AND FIELD OF THE INVENTION

The invention relates to an apparatus and method of measuring, monitoring, recording and verifying that the uptake and discharge of ballast water on marine vessels are clean and comply with regulatory standards to prevent the invasion of foreign species. The regulatory standards are set by international bodies like the International Maritime Organisation (IMO) and the United States Coast Guard (USCG).

Ballast water is carried by marine vessels to maintain their stability and seaworthiness when cargoes are loaded or unloaded. About 10,000 marine species are transported around the world in ballast water. This poses an ecological threat due to the transfer of species that become invasive and puts native species at risk. As a result, international organization like the International Maritime Organisation (IMO) and the United States Coast Guard (USCG) have imposed ballast water discharge standards that marine vessels must comply with when discharging ballast water at ports.

Various ballast water treatment systems have been developed to treat the ballast water to ensure that it meets the ballast water discharge standards. Generally, most ballast water treatment technologies involve methods of filtering away bacteria and pathogen cells larger than 50 microns in the first stage, and then tallow by the processes of actively killing the remaining bacteria and pathogens with treatment options such as UV light, electro-chlorination, deoxygenation, heating/pasteurisation, injection of active substances, for example. These ballast water treatment methods are rather aggressive. They consume lot of power which cause emission pollution to the environment while saving the ecology of the ocean. As these treatment methods need to actively kill the bacteria and pathogens in the ballast water to meet the ballast water discharge standards, the bigger marine vessels with bigger ballast capacity will require bigger treatment systems. Systems employing these methods also require huge amount of space and extensive retrofit and installation work. They are rather complicated and costly.

A ballast water system without or before the ballast water treatment system is retrofitted or installed is, generally, illustrated by FIG. 1. During the ballast water uptake when the marine vessel is ballasting, the Coarse filter 103, generally of about 4 mm to 8 mm mesh size, filters out the big articles from the ballast water uptake which are sucked in from the sea chest 101. The filtered ballast water is then pumped by the Ballast Water pump 104 to the ballast water tanks 105. During the discharge operation when the marine vessel is de-ballasting, the ballast water is pumped or flowed by gravity to overboard 106. By opening or closing the appropriate and necessary series of valves 102, the ballast water system can either uptake ballast water from the sea chest 101 or discharge the ballast water from the ballast tanks to overboard (sea, lake or river) 106.

The ballast water system after the retrofitting or installation of a Ballast Water Treatment System is, generally, illustrated by FIG. 2. The newly retrofitted or installed components include the Ballast Water Fine Filter with automatic back washing 201, the Treatment System 202 and a Controller. The Ballast Water Fine Filter 201 filters away bacteria and pathogens which are larger than about 40 microns to 50 microns in size. The Ballast Water Fine Filter is usually provided with automatic back washing to unclog the fine filter and prevent it from chocking. The Ballast Water Treatment System (BWTS) 202 generally, uses one or combinations of the processes of actively killing the remaining bacteria and pathogens after fine filtering. The treatment process options are namely, by UV light, electro-chlorination, deoxygenation, heating/pasteurisation, injection of active substances, for example.

The purpose of this invention is to overcome the disadvantage of prior art whereby the treatment of ballast water by killing the bacteria and pathogens to meet the regulatory ballast water discharge standards requires high amount of power. For example, typical power requirement of prior art is in the order of 100 to 150 kW or more, to treat ballast water capacity of about 1,000 cubic meter per hour. This invention replaces the ballast water treatment system 202 with the Ballast Water Management System 304 & 509 as illustrated by FIGS. 3 & 5. The components of the Ballast Water Management System 304 & 509 comprise a small ballast water sampling pump 503 & 603, a ballast water flow meter 504 & 604, a ballast water monitor 505, and the ballast water sensors module 506. The ballast water sensors module 506 comprises various sensors that measure the parameters such as but are not limited to: turbidity, temperature, salinity, PH and dissolved oxygen. The Ballast water monitor and sensors module 605 comprising the ballast water monitor 505 and the ballast water sensors module 506 may be enclosed in a protective enclosure made of steel, plastic, fibreglass or other materials as illustrated in FIG. 6. The Ballast Water Management System 304 & 509 as illustrated in FIGS. 3 & 5 takes a small representative sample of about 10 cubic meter per hour of the ballast water from the main ballast water pipe through the small sampling pipe 302 & 601 via valve 301. The sampled ballast water is returned from the Ballast Water Management System 304 & 509 to the main ballast water pipe through the small sampling pipe 303 & 602 via valve 301. The diameter of the small sampling pipes is about 50 mm. There is no treatment of the ballast water. The invention ensures that the discharge ballast water of the marine vessel complies with the ballast water discharge standards set by international bodies like the IMO and USCG, by automatically and continuously measuring, monitoring, recording and verifying the ballast water uptake and discharge to ensure that non-compliant water is not allowed to enter the ballast water tanks or to be discharged overboard from the ballast tanks. In the case that non-compliant water is required to enter specific ballast water tank to provide safe stability and sea-worthiness to the marine vessel, the specific amount of non-compliant water and the specific ballast water tank are identified and isolated so that when compliant water is available, for example in mid-ocean, the non-compliant water will be totally flushed out by the complaint water. Thus, no power is required to operate any aggressive treatment processes resulting in substantial reduction in power consumption compared to prior art. It is estimated that the total power requirement of the invention is less than 10 kW for sampling capacity of about 10 cubic meter per hour. The total power consumption of this invention is due mainly to the power required by namely, the small sampling pump, the flow meter, the ballast water monitor, the various sensors of the ballast water sensors module, the auto quick acting valves and the Controller.

Another purpose of this invention is to overcome the disadvantage of prior art whereby the Ballast Water Treatment System 202 as, generally, illustrated by FIG. 2 requires a lot of space and extensive retrofitting or installation work. Generally, the required extensive retrofitting or installation work of prior art requires the marine vessel to be dry docked which disrupts its operation. This invention obviates the requirement for extensive retrofitting or installation work and the need for the marine vessel to dry dock. With a sampling pump 503 & 603 as illustrated in FIGS. 5 & 6, the small sampling flow rate does not depend on the distance “x” 308 to provide the differential pressure in the main ballast pipe for the sampling ballast water to flow. Thus, the distance “x” (between the small intake pipe 302, 501 & 601 and the small return pipe 303, 508 & 602) can be designed to be as short as possible, for example 100 mm or more. The diameter of the sampling pipes is 50 mm. The small diameter enables the sampling pipe runs to be easily retrofitted or installed. The small sampling rate is but not limited to, about 10 cubic meter per hour irrespective of the main ballast water capacities which may range from 100 to 20,000 cubic meter per hour. The size of the equipment required to handle the sampled ballast water is thus only a fraction of the Ballast Water Treatment System which is required to handle the larger main ballast water capacity. The size of the invention can thus, be designed to be very small and compact compared to prior art. The retrofit or installation work required by the invention is easy and quick, without the need to dry dock the marine vessel.

Another further purpose of this invention is to overcome the disadvantage of prior art whereby marine vessels of different main ballast water capacities would require different Ballast Water Treatment System 202 of different sizes and capacities. The practical range of main ballast water capacities are, generally, from about 100 to 20,000 cubic meter per hour. This invention allows marine vessels with different main ballast water capacities from but not limited to, 100 to 20,000 cubic meter per hour, to be managed by a standard and compact ballast water management system of one size of sampling capacity of but not limited to, about 10 cubic meter per hour without adversely affecting the sampling process. It obviates the need to have different sizes and capacities of ballast water management system to cater to different sizes of marine vessels of different main ballast water capacities.

The advantageous features of the invention provide for a simpler and standardised ballast water management system which is less costly, more energy efficient, easier to retrofit or install, and easier to operate and maintain with less parts which are standardised.

The preferred embodiment of the invention consists of the Ballast Water Management System 304 & 509 and the Controller 306, 513 & 607 as illustrated in FIGS. 3, 5 & 6. FIG. 4 illustrates the option of including a fine filter 401 before the Ballast Management System to remove any articles of sizes 40 to 50 microns or bigger. The components of the Ballast Water Management System comprise a small ballast water sampling pump 503 & 603, a ballast water flow meter 504 & 604, a ballast water monitor 505, and the ballast water sensors module 506. The ballast water sensors module 506 comprises various sensors that measure parameters such as but not limited to: turbidity, temperature, salinity, PH and dissolved oxygen. The Ballast water monitor & sensors module 605 comprising the ballast water monitor 505 and the ballast water sensors module 506 may be enclosed in a protective enclosure made of steel, plastic, fiberglass or other materials as illustrated in FIG. 6. The Ballast Water Management System 304 & 509 as illustrated in FIGS. 3 & 5 takes a small and representative sample of the ballast water from the main ballast water pipe through the small sampling pipe 302, 501 & 601 via valve 301. The sampling rate is but not limited to, about 10 cubic meter per hour. The sampled ballast water is returned from the Ballast Water Management System to the main ballast pipe through the small sampling pipe 303, 508 & 602 via valve 301. The diameter of the sampling pipes is 50 mm. The Ballast Water Management System 304 & 509 measures the parameters of the sampled ballast water. The measured parameters 305, 511 & 606 are stored in the Controller 306, 513 & 607 which monitors the parameters of the ballast water against the ballast water discharge standards set by international regulators like IMO and USCG. The Controller also monitors and records the ship data 307, 512 & 608 from the automated identification system (AIS). The ship data 307, 512 & 608 comprises data such as but not limited to, coordinates, course, speed, heading, current draught, destination, ETA, static ship data and time/date stamp. Additionally, the Controller controls the ballast water sampling pump 503 & 603 and the valves. The Controller automatically and continuously monitors, records and verifies the measured parameters of the sampled ballast water during the uptake and discharge operations against the ballast water discharge standards set by the regulators like IMO and USCG. It also continuously monitors and records the ship data from the AIS and synchronise and match the ship data to the measured parameters of the ballast water so that the measured parameters are verifiable and traceable. The Controller ensures that non-compliant water during the marine vessel's ballasting and de-ballasting operations, are not pumped into the ballast tanks or discharged overboard at ports, respectively, by opening or closing the appropriate and necessary series of valves. It is obvious to those skilled in engineering design that this can be achieved by activating the appropriate and necessary quick acting valves in the main ballast water pipes.

It is an object of the invention to provide an apparatus and a method of automatic and continuous measuring, monitoring, recording and verifying the clean uptake and discharge of ballast water on marine vessels which address the disadvantages of prior art.

### SUMMARY OF THE INVENTION

In accordance to the first aspect of the invention, the preferred embodiment of the invention is illustrated in FIG. 6. The ballast water sampling pump 603 sucks in the representative sample of ballast water through a small sampling pipe 601 from the main ballast water pipe. The sampling pump is controlled by the control signal 609 from the Controller 607. The small sampling rate of but not limited to, about 10 cubic meter per hour, is measured by the ballast water flow meter 604. The Ballast water monitor 505 and the Ballast water sensors module 506 are enclosed in the protective enclosure 605. After the parameters of the ballast water sample are measured, the ballast water sample is returned to the main ballast pipe through the small return pipe 602. The measured parameters 606 of the ballast water sample by the flow meter, ballast water monitor and the ballast water sensors module are digitally transmitted to the Controller. The Controller also receives the ship data 608 from the vessel's Automatic Identification System (AIS). The measured parameters (Ballast Water Data) and ship data are synchronized, matched and stored in the storage device of the Controller in a secure, tamper-proof and encrypted format so that they are verifiable and traceable.

In another aspect of the invention, the preferred embodiment of the invention as illustrated by FIGS. 3 and 6 may include the option of including a fine filter 401 which is located before the Ballast Management System to remove articles which are 40 to 50 microns in size or bigger.

In accordance with the second aspect of the present invention, there is provided a method of automatic and continuous measuring, monitoring, recording and verifying that the ballast water uptake and discharge comply with the ballast water discharge standards set by international bodies like the IMO and USCG. The measurements of the ballast water monitor 505 is automatically and continuously compared by the Controller 607 against the ballast water discharge standards and the results are used to control the closing and opening of the appropriate and necessary series of auto quick acting valves to ensure that only compliant ballast water is allowed to be pumped into the ballast tanks during ballasting or to be discharged overboard at the ports from the ballast tanks during de-ballasting. It is obvious to those skilled in engineering design that this can be achieved by activating the appropriate and necessary series of quick acting valves in the main ballast water pipes. The Controller also compares the measurements of the ballast water monitor against the historical data of similar ship data and other data such as but is not limited to: turbidity, ballast water velocity, temperature, salinity, PH and dissolved oxygen. The ship data comprises data such as but is not limited to: coordinates, course, speed, heading, current draught, destination, ETA, static ship data and time/date stamp. The results of the comparisons of the ballast water monitor measurements against historical data are used as a check against the results of the current comparisons of the ballast water monitor measurements against the ballast water discharge standards.

In another aspect of the present invention, there is provided a method of automatic and continuous monitoring, recording and verification of information associated with the ballast water uptakes held in each specific ballast water tanks during the ballasting of the marine vessel. The information comprises the amount of ballast water, all the measured ballast water parameters and the ship data associated with the specific ballast water held in the specific ballast water tank. The information is saved in the storage device of the Controller in a secure, tamper-proof and encrypted format. In the unlikely event that specific ballast water held in specific ballast water tank is found to be non-compliant during ballasting or de-ballasting, the specific ballast water tank shall be identified and isolated. When compliant ballast water uptake is available, for example, at mid-ocean, the specific non-compliant ballast water in the identified specific ballast water tank shall be flushed out with the compliant ballast water uptake.

It should be understood that the invention is an apparatus and a method for measuring, monitoring, recording and verifying that the ballast water uptake and discharge on marine vessels are clean and comply with regulatory standards to prevent the invasion of foreign species.

It should be appreciated that features of one aspect may also be applicable to another aspect.

### BRIEF DESCRIPTION OF THE DRAWINGS

An example of the invention will now be described with reference to the accompanying drawings, in which:

FIG. 1 illustrates a ballast water system of a marine vessel which is without any ballast water management or ballast water treatment system.

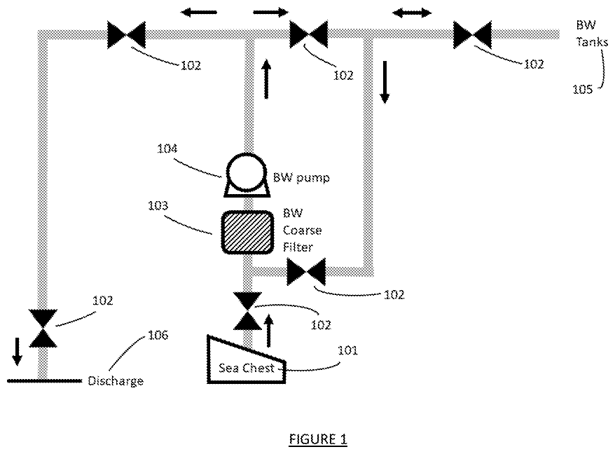

FIG. 2 illustrates a ballast water system of a marine vessel which is retrofitted or installed with a ballast water treatment system.

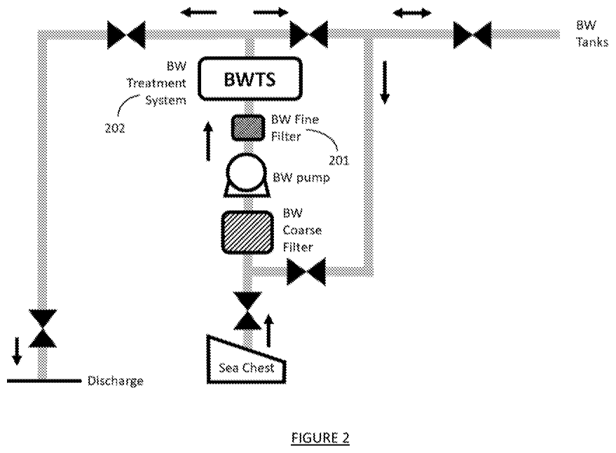

FIG. 3 illustrates a ballast water system of a marine vessel which is retrofitted or installed with the invention.

FIG. 4 illustrates a ballast water system of a marine vessel which is retrofitted or installed with the invention and an additional option of a ballast water fine filter.

FIG. 5 illustrates the details of the components of the invention.

FIG. 6 is a pictorial illustration of the design and parts of the preferred embodiment of the invention.

### DETAILED DESCRIPTION OF PREFERRED EMBODIMENT

The following definitions will be used throughout these specifications:

Automatic Identification System, AIS—an automatic tracking system which is extensively used on marine vessels and by vessel traffic services for the exchange of navigational information.

Ballast water tank—is a compartment or tank within a marine vessel that is used to hold ballast water to provide or improve the stability for the marine vessel

Ballast water—refers to the water (sea water, fresh water or brackish water) carried in the marine vessel's ballast tanks to improve stability, balance and trim. It is taken up or discharged when cargo is unloaded or loaded respectively, or when the marine vessel needs to improve stability.

Ballast water treatment system—refers to a system designed to treat ballast water using processes which may be a combination of mechanical, physical or chemical methods to remove, kill or render harmless the organisms within the ballast water.

Ballast Water Discharge Standard—as of September 2018, the Ballast Water Discharge Standard refers to:
(1) For organisms greater than or equal to 50 micron: discharge must include fewer than 10 organisms per cubic meter of ballast water
(2) For organism less than 50 micron and great than 10 micron: discharge must include fewer than 10 organisms per milliliter of ballast water
(3) Indicator microorganisms must not exceed:
   i. For toxicogenic vibro cholerae (serotypes O1 and O139): a concentration of less than 1 colony forming unit (cfu) per 100 mL
   ii. For Escherichia coli: a concentration of less than 250 colony forming unit (cfu) per 100 mL
   iii. For intestinal enterococci: a concentration of less than 100 colony forming unit (cfu) per 100 mL

Ballast Water Monitor—a sensor which measures the concentration and size of the bacteria and pathogens in ballast water

Controller—refers to the electronic box which is used to manage and control the operation of the invention. It receives and stores digital information from the ballast water monitor, ballast water sensors, the Automatic Identification System and other equipment or systems. It has computing capability to compute and execute logical processes. It controls the operation of the sampling pump, the automatic ballast water valves and other devices. It has man-machine interface comprising graphical display and physical control buttons & switches to allow users to interact with the invention.

IMO—International Maritime Organisation is the United Nations agency responsible for management and implementation of the international convention for the control and management of ship's ballast water and sediments.

Marine vessel—any ships, boats, rigs or crafts such as but not limited to cruise ships, ferries, tankers, container ships, bulk carriers, ice breakers, oil rigs, yachts and so on, used for transportation on water

Sea Chest—is a rectangular recess which provides an intake reservoir near the bottom of a marine vessel, from which piping systems draw raw water for cooling, ballast and other purposes.

Storage device—a computer or electronic device on which digital information can be stored

Secure, tamper-proof and encrypted—the technique to transform digital information into a format so that the digital information cannot be modified, accessed or read by unauthorized personnel.

USCG—United States Coast Guard is the branch of the United States military which is responsible for an array of maritime duties, including the management and implementation of the USCG ballast water discharge regulations.

Valve—generally refers to ballast water butterfly valve which may be manually or automatically operated.

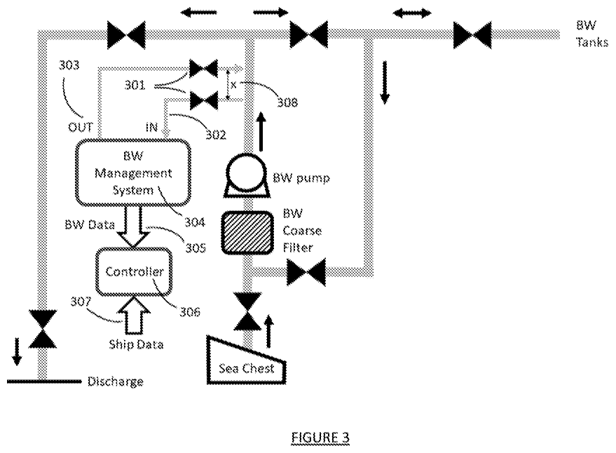

FIG. 3 shows the schematic layout of the invention within the ballast water system of the marine vessel. The Ballast Water Management System 304 is retrofitted or installed at the location, just after the Ballast Water pump. The Ballast Water Management System automatically and continuously takes the representative sample of ballast water from the main ballast water pipes through a small sampling pipe 302. The sampled ballast water is returned from the Ballast water Management System to the main ballast water pipe through the small sampling pipe 303. Both the intake and return sampling pipes 302 & 303 are jointed to the main ballast water pipe via the valves 301. The distance “x” 308 between the joints of the intake and return sampling pipes to the main ballast pipe, is designed to be as short as possible. “x” is but not limited to, about 100 mm or more. The diameter of the small sampling pipes is about 50 mm. The Ballast Water Data 305 (the results of the measurements of the Flow Meter 504, Ballast Water Monitor 505 and Ballast Water Sensors Module 506) are transmitted digitally to the Controller 306 and saved in a secure, tamper-proof and encrypted format. The Ballast Water Sensors Module data comprises but is not limited to the following parameters: ballast water velocity, turbidity, temperature, salinity, PH and dissolved oxygen. The Controller also continuously monitors and saves the ship data 306 in a secure, tamper-proof and encrypted format. The ship data are received from the Automatic Identification System (AIS) of the marine vessel and it comprises but is not limited to the following: coordinates, course, speed, heading, current draught, destination, ETA, static ship data and time/date stamp. The Ballast Water Data and the Ship Data are time-stamped so that they are synchronized and matched.

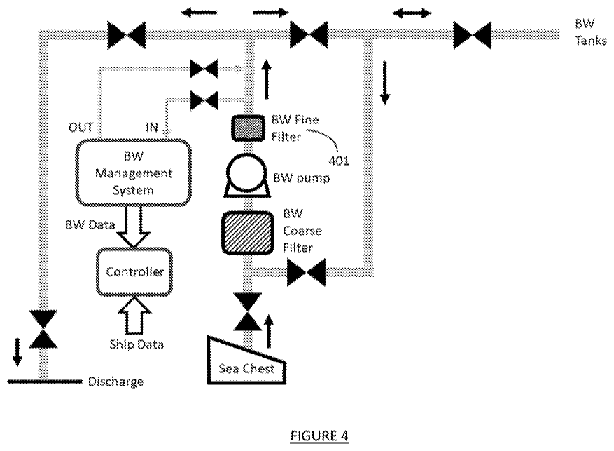

FIG. 4 shows the schematic layout of the invention within the Ballast Water System of the marine vessel, with an optional fine filter 401 retrofitted or installed at the location before the Water Ballast Management System. The optional fine filter will remove articles of size of 40 to 50 microns or bigger from the main ballast water before it is sampled by the Ballast Water Management System.

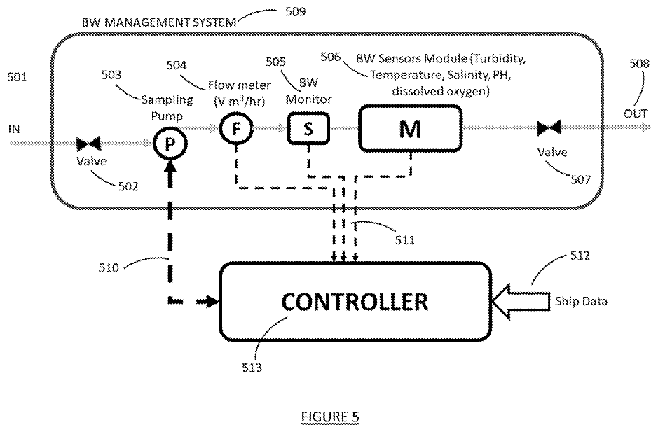

FIG. 5 shows the schematic details of the components of the invention. Similarly, as illustrated by FIGS. 3 & 4, the Ballast Management System 509 takes in the representative of sample ballast water from the main ballast water pipe through the small sampling intake pipe 501 of about 50 mm in diameter via the valve 502. The sampled ballast water is returned from the Ballast Water Management System to the main ballast pipe through the small discharge sampling pipe 508 of about 50 mm in diameter via the valve 507. The small sampling flow rate of but not limited to, about 10 cubic meter per hour is maintained by the sampling pump 503 which is controlled by the control signal 510 from the Controller 513. The sampling flow rate is measured by the flow meter 504. The Ballast Water Monitor 505 automatically and continuously measures the concentration of bacteria and pathogens in the sampled ballast water. The Ballast Water Sensors Module 506 measures by using various off-the-shelf sensors, the following but not limited to, ballast water parameters: turbidity, ballast water velocity, temperature, salinity, PH and dissolved oxygen. All the measured ballast water parameters 511 are digitally transmitted to the Controller 513 and saved in a secure, tamper-proof and encrypted format. The Controller also continuously monitors, records and saves the ship data 515 in a secure, tamper-proof and encrypted format.

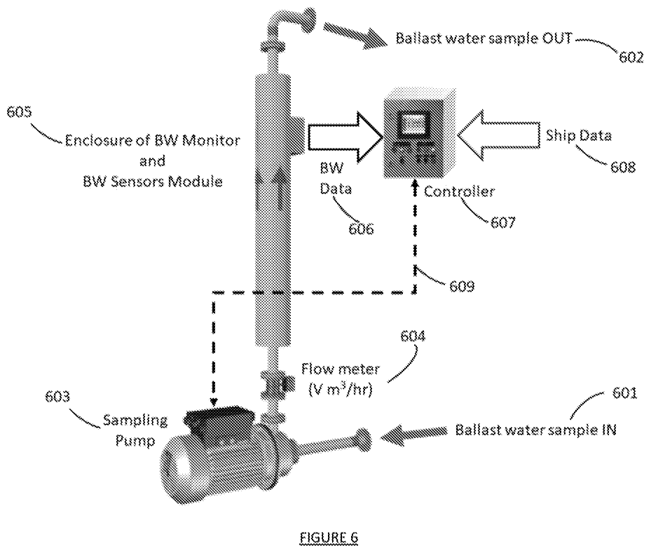

FIG. 6 shows the pictorial illustration of the design and the parts of the preferred embodiment of the invention. The small sampling pump 603 sucks in the representative sample of ballast water 601 from the main ballast pipe through the small sampling pipe. The ballast water sample 602 is returned to the main ballast pipe through the small sampling pipe as illustrated. The sampling pump 603 is controlled by the control signal 609 from the Controller 607. The sampling flow rate is measured by the flow meter 604. The Ballast Water Monitor 505 and the Ballast Water Sensors Module 506 is enclosed as illustrated by an protective enclosure which may be made from steel, plastic, fibreglass or other suitable materials. As illustrated in FIGS. 3, 4 & 5, all the measured ballast water parameters 606 are digitally transmitted to the Controller 607 and saved in a secure, tamper-proof and encrypted format. The Controller also continuously monitors and saves the ship data 608 in a secure, tamper-proof and encrypted format.

During the uptaking or discharging of the ballast water when the marine vessel is ballasting or de-ballasting respectively, the Ballast Water Monitor 505 automatically and continuously measures the concentration of the bacteria and pathogens in the sampled ballast water. The sampling rate of the ballast water is measured by the flow meter 504 & 604. Other ballast water parameters such as but no limited to, turbidity, temperature, salinity, PH and dissolved oxygen are also automatically and continuously measured by the Ballast Water Sensors Module 506 using various off-the-shelf sensors. The results of all the measured parameters 305, 511 & 606 of the ballast water sample are sent to the Controller 306, 513 & 607 and saved in the storage device of the Controller in a secured, tamper-proof and encrypted format. The Controller also automatically and continuously monitors and receives the ship data 307, 512 & 608 such as but not limited to coordinates, course, speed, heading, current draught, destination, ETA, static ship data and time/date stamp from the vessel's Automatic Identification System (AIS). The ship data is saved in the storage device of the Controller in a secured, tamper-proof and encrypted format. Additionally, the Controller also monitors and records the information (the ballast water data and the ship data) of the specific ballast water held in each specific ballast tanks.

During the ballast water uptake when the marine vessel is ballasting, the Controller 306, 513 & 607 automatically and continuously compares the results of the Ballast Water Monitor 505 against regulatory requirements specified by IMO and USCG. If the measured results of the ballast water uptake by the Ballast Water Monitor do not comply with the regulatory standards specified by regulatory bodies like the IMO and USCG, the ballast water taken via the sea chest 101 shall be immediately discharged overboard back into the sea, lake or river 106. The Controller shall not allow any non-compliant ballast water uptake to be pumped to the ballast water tanks 105.

During the ballast water discharge when the marine vessel is de-ballasting, the Controller 306, 513 & 607 automatically and continuously compares the results of the Ballast Water Monitor 505 against regulatory requirements specified by IMO and USCG. If the measured results of the ballast water to be discharged by Ballast Water Monitor do not comply with the regulatory ballast water discharge standards specified by regulatory bodies like the IMO and USCG, the Controller shall not allow the non-compliant ballast water from the ballast tanks to be discharged overboard 106.

Additionally, during the ballast water discharge when the marine vessel is de-ballasting, the Controller 306, 513 & 607 also automatically and continuously compares the results of the Ballast Water Monitor 505 against historical data of similar ship data and ballast water data. The results of the comparisons of Ballast Water Monitor measurements against the historical data are used as a check against the results of the current comparisons of the Ballast Water Monitor measurements against the ballast water discharge standards.

All the measured ballast water parameters 305, 511 & 606, the ship data 309, 512, 608 and the open/close status of the valves during the ballast and de-ballasting of the marine vessels are time-stamped and saved in a secure, tamper-proof and encrypted format so that they are synchronized and matched. Thus, all the ballasting and de-ballasting information are verifiable and traceable to ensure that no non-compliant ballast water has been discharged overboard at ports.

1-14. (canceled)

15. A method of sampling and measuring, monitoring, recording and verifying ballast water uptake and discharge during ballasting and de-ballasting of marine vessel respectively, the method comprising:
(i) automatic and continuous sampling of ballast water using a sampling pump of a flow rate of about 10 cubic meter per hour, wherein the sampling pump is connected to a sampling intake and return pipe with a diameter of about 50 mm;
(ii) automatic and continuous measuring of concentration of bacteria and pathogens in the sampled ballast water using a Ballast Water Monitor to obtain time-stamped results of measurements; and sending the time-stamped results of measurements digitally to a Controller to be saved in a storage device of the Controller in a secure, tamper-proof and encrypted format;
(iii) automatic and continuous measuring of various parameters of the sampled ballast water using a sensor module consisting of a plurality of sensors to obtain time-stamped measured sampled ballast water parameters and sending the time-stamped measured sampled ballast water parameters to the Controller to be saved in the storage device of the Controller in a secure, tamper-proof and encrypted format;
(iv) automatically and continuously receiving ship data by the Controller from a marine vessel's Automatic Identification System (AIS) and saving the received ship data in the storage device of the Controller in a secure, tamper-proof and encrypted format;
(v) automatic and continuous monitoring and recording of time-stamped information associated with the ballast water uptakes held in each specific ballast water tank during ballasting and de-ballasting of the marine vessel, wherein the time-stamped information comprises the time-stamped results of measurements obtained in step (ii), the time-stamped measured sampled ballast water parameters obtained in step (iii) and the ship data obtained in step (iv) associated with the ballast water held in the specific ballast tank and saving the time-stamped information in the storage device of the Controller in a secure, tamper-proof and encrypted format; and
wherein when the marine vessel is uptaking ballast water during ballasting, the Controller automatically and continuously compares the time-stamped results of measurements obtained by the Ballast Water Monitor against regulatory ballast water discharge standards, and if the time-stamped results of measurements do not comply with the regulatory ballast water discharge standards, the Controller immediately discharges the non-compliant ballast water taken in via a sea chest overboard back into sea, lake or river, by opening or closing appropriate series of valves to prevent the non-compliant ballast water uptake to be pumped and flowed into the ballast water tank.

16. The method according to claim 15, wherein when the marine vessel is discharging the ballast water overboard during de-ballasting, the Controller automatically and continuously compares the time-stamped results of measurements obtained by the Ballast Water Monitor against the regulatory ballast water discharge standards, and if the time-stamped results of measurements do not comply with the regulatory ballast water discharge standards, the Controller will re-circulate the non-compliant ballast water within main ballast water pipes or pump the non-compliant ballast water back into the ballast water tank by opening or closing appropriate series of valves in the main ballast water pipes to prevent the non-compliant ballast water from the ballast water tank from discharging overboard.

17. The method according to claim 15, wherein when the non-compliant water is required to enter specific ballast water tank to provide safe stability and sea-worthiness to the marine vessel, the specific amount of non-compliant water and the specific ballast water tank are monitored, recorded, identified and isolated, and wherein when the compliant ballast water uptake is available, the specific non-compliant ballast water in the identified specific ballast water tank is totally flushed out by the compliant water.

18. The method according to claim 15, wherein when the marine vessel is uptaking or discharging the ballast water during ballasting or de-ballasting of the marine vessel respectively, the Controller automatically and continuously compares the time-stamped results of the measurements obtained by the Ballast Water Monitor against historical data of similar ship data and other data, wherein the results of the comparisons of the Ballast Water Monitor measurements against the historical data are used as a check against the results of current comparisons of the Ballast Water Monitor measurements against the regulatory ballast water discharge standards.

19. The method according to any claim 15, further comprising:
monitoring, recording, date/time stamping and saving the time-stamped measured sampled ballast water parameters, the ship data and the open/close status of the valves in the storage device of the Controller in a secure, tamper-proof and encrypted format to provide a verifiable and traceable method to ensure that no non-compliant ballast water has been discharged overboard.

20. The method according to any claim 15, further comprising:
maintaining the automatic and continuous sampling rate by the sampling pump at a flow rate of about 10 cubic meter per hour, irrespective of the main ballast water flow rate through the main ballast pipes.

21. The method according to claim 15, wherein the parameters of the sampled ballast water include ballast water velocity, turbidity, temperature, salinity, pH and dissolved oxygen.

22. The method according to claim 15, wherein the ship data includes coordinates, course, speed, heading, current draught, destination, ETA, static ship data and time/date stamp.

23. A ballast water system for sampling and measuring, monitoring, recording and verifying ballast water uptake and discharge during ballasting and de-ballasting of marine vessel respectively, the system comprising:
a ballast water management system comprising:
a sampling pump configured to have a flow rate of about 10 cubic meter per hour;
a sampling intake and return pipe connected to the sampling pump, wherein the sampling intake and return pipe has a diameter of about 50 mm;
a Ballast Water Monitor for measuring concentration of bacteria and pathogens in sampled ballast water to obtain time-stamped results of measurements;
a sensor module consisting of a plurality of sensors connected to the Ballast Water Monitor for measuring various parameters of the sampled ballast water; and
a plurality of valves for controlling flow of the ballast water; and
a Controller configured to receive (i) the time-stamped results of the measurements digitally from the Ballast Water Monitor; (ii) the time-stamped measured sampled ballast water parameters digitally from the plurality of sensors; and (iii) ship data from marine vessel's Automatic Identification System (AIS), and saving them in a storage device of the Controller in a secure, tamper-proof and encrypted format; and
wherein the ballast water system is configured to allow automatic and continuous monitoring and recording of time-stamped information associated with the ballast water uptakes held in each specific ballast water tank during ballasting and de-ballasting of the marine vessel and saving the time-stamped information in the storage device of the Controller in a secure, tamper-proof and encrypted format; and
wherein the Controller is configured to automatically and continuously compares the time-stamped results of measurements obtained by the Ballast Water Monitor against regulatory ballast water discharge standards, and if the time-stamped results of measurements do not comply with the regulatory ballast water discharge standards, the Controller immediately discharges the non-compliant ballast water overboard back into sea, lake or river, by opening or closing appropriate valves to prevent the non-compliant ballast water uptake to be pumped and flowed into ballast water tank.

24. The ballast water system according to claim 23, wherein the Controller is configured to automatically and continuously compares the time-stamped results of measurements obtained by the Ballast Water Monitor against the regulatory ballast water discharge standards, and if the time-stamped results of measurements do not comply with the regulatory ballast water discharge standards, the Controller re-circulates the non-compliant ballast water within main ballast water pipes or pump the non-compliant ballast water back into the ballast water tank by opening or closing appropriate valves in the main ballast water pipes to prevent the non-compliant ballast water from the ballast water tank from discharging overboard.

25. The ballast water system according to claim 23, wherein the ballast water management system and the Controller are sized as a standard and compact equipment of one size of sampling capacity of 10 cubic meter per hour to cater to marine vessels of main ballast water capacities ranging from 100 to 20,000 cubic meter per hour.

26. The ballast water system according to claim 23, wherein the total power requirement of the ballast water system comprising the sampling pump, the Ballast Water Monitor, the sensor module, the plurality of valves and the Controller is less than 10 kW for all ballast water capacities of the marine vessel from 100 to 20,000 cubic meter per hour due to absence of any ballast water treatments.

27. The ballast water system according to claim 23, wherein the parameters of the sampled ballast water include ballast water velocity, turbidity, temperature, salinity, pH and dissolved oxygen.

28. The ballast water system according to claim 23, wherein the ship data includes coordinates, course, speed, heading, current draught, destination, ETA, static ship data and time/date stamp.
